(19) United States
(12) Patent Application Publication
(10) Pub. No.: US 2023/0286062 A1
(43) Pub. Date: Sep. 14, 2023

(54) WORKPIECE HOLDING DEVICE

(71) Applicant: AKTIEBOLAGET SKF, GOTEBORG (SE)

(72) Inventors: Gerhard WAGNER, Prichsenstadt (DE); Fred MENIG, Sulzthal (DE); Martina STICHT, Sennfeld (DE); Michael WENDEL, Bremen (DE)

(21) Appl. No.: 18/117,607

(22) Filed: Mar. 6, 2023

(30) Foreign Application Priority Data
Mar. 11, 2022 (DE) 102022202466.4

(51) Int. Cl. B23B 31/16

(52) U.S. Cl. CPC B23B 31/16275

(57) ABSTRACT

A workpiece holding device for holding a workpiece in a heat treatment system while the workpiece undergoes a thermal expansion and/or contraction includes at least two clamping units configured to apply a radial and/or an axial clamping force to the workpiece to hold the workpiece in the workpiece holding device in a predefined position, and at least three support units configured to support the workpiece. A first one of the at least three support units includes a first cylinder configured to support the workpiece, the first cylinder having a longitudinal axis and being configured to rotate around the longitudinal axis.

### CROSS REFERENCE

This application claims priority to German patent application no. 10 2022 202 466.4 filed on Mar. 11, 2022, the contents of which are fully incorporated herein by reference.

### TECHNOLOGICAL FIELD

The present disclosure is directed to a workpiece holding device for the receiving of a workpiece in a heat-treatment system, wherein due to a heat treatment the workpiece experiences a thermal expansion and/or contraction, or an expansion and/or contraction due to a density difference arising in the microstructure during the phase transformation.

### BACKGROUND

In order to thermally treat workpieces, for example to heat or quench them, the workpieces must be arranged securely and in a precise position relative to the treatment system in order to achieve very accurate heat input and subsequently defined quenching processes of the treatment zones. For this purpose conventional clamping means can be used, such as, for example, so-called three- or four-jaw chucks that include three or four clamping jaws that are mounted on a work table and grouped circumferentially around the tool to be held. In these clamping jaws, prior to the treatment of the workpiece, the workpiece is clamped and held, wherein a repositioning of the clamping jaws is possible in order to compensate for a thermal contraction and/or expansion, or a contraction and/or expansion due to a density difference arising in the microstructure during the phase transformation. Furthermore, it is known with such devices to move the entire work table, together with the clamping jaws, past fixed heat sources in order to simplify the repositioning of the supply lines needed for the heat sources.

A disadvantage of this device, however, is that the force required for tracking the clamping jaws due to the thermal expansion or contraction to be compensated for caused by a density difference arising during the phase transformation in the microstructure may be too low, and it may then come about that the clamping jaws no longer lie against the workpiece and thus cannot hold it sufficiently, or that an excessively high application of force by the clamping jaws leads to deformation of the workpiece.

Furthermore, with the known devices it is problematic that the large mass to be moved comprised of work table, clamping jaws, and workpiece leads to very high wear in the drive system of the work table so that its components must often be replaced or the drive must be completely exchanged. Also, due to the large mass to be moved and the dimensions of the device, overall limits are set for the process parameters, such as for example, a relative speed between inductor and workpiece, with the result that an optimized heat input into the workpiece cannot always be achieved.

However, the heat input and the distribution of the heat input in the workpiece are of enormous importance in order to achieve the desired workpiece properties in the treatment zones and to control the resulting dimensional and shape changes (workpiece warpage). Known possibilities for influencing the heat input and the temperature distribution in the case of the example of an inductive hardening are a suitable choice of the process parameters or of the process design (electrical power, heating time, heating frequency, inductor-workpiece coupling distance, inductor material, inductor design, targeted use of magnetic field concentrators, workpiece material, previous condition of the workpiece material, relative speed of the workpiece with respect to the inductor, etc.)

### SUMMARY

The workpiece holding device is therefore a decisive element of the heat-treatment system and of the success of the heat treatment. It is therefore an aspect of the present disclosure to provide a workpiece holding device, in particular a workpiece clamping system, that fulfills the following functions, preferably holistically:
Ensure a predefined inductor-workpiece coupling distance;
Position the workpiece in a defined position;
Hold the workpiece in a defined position against the acting forces (e.g., magnetic fields) during the entire process time;
Ensure good reproducibility of the heat treatment;
Allow the heat treatment at all positions of the workpiece (inside, outside, side surfaces above and below);
Avoid crack formation; and
Make possible a minimization of the resulting workpiece warpage.

In the following, a workpiece holding device is presented for holding a workpiece in a heat-treatment system, wherein the workpiece received in the workpiece holding device experiences a thermal expansion and/or contraction, or an expansion and/or contraction due to a density difference arising in the microstructure during the phase transformation. In the following, only thermal expansion or contraction is discussed since even with a phase transformation a thermal component is usually present. Furthermore, the workpiece holding device includes at least two clamping units that are designed to apply a radial and/or axial clamping force to the workpiece so that the workpiece is positioned in the workpiece holding device in a predefined position. The workpiece is in particular a closed curves that is preferably designed rotationally symmetric, such as, for example, an element of a plain or rolling-element bearing, a bearing ring, a gear, a bolt, a sleeve, a disc, etc.

In order to allow a best-possible accessibility to the workpiece and thus a heat treatment at all positions, in particular even on a surface facing the workpiece holding device, and at the same time to reduce the wear of the components of the workpiece holding device, in particular due to a high mass, and at the same time to optimize the heat input into the workpiece, furthermore at least two, preferably at least three, support units are present that are configured such that the workpiece is supported by them, wherein at least one of the support units includes a cylinder rotatable about its longitudinal axis so that the workpiece itself can be moved via the support units.

The axially rotatable cylinder thus ensures a flat contact surface and at the same time, due to its rotatability, an easy and low-friction moving of the workpiece over the cylinder. In addition, it can be ensured by the plurality of support units that the workpiece is supported in a tilt-free manner.

Here it is preferred in particular when the rotatable cylinder is configured as a drive unit (is driven by a motor) and is designed to move, in particular to set in rotation, the abutting workpiece. A drive unit can thereby be provided that moves the workpiece easily and cost-effectively. In addition, since only the workpiece, but not the entire unit comprised of workpiece, work table, clamping units, and further equipment, must be set into motion, even with large workpieces a large weight reduction can be achieved of the parts to be set in motion. This in turn also allows, in addition to the lower loading of the components and thus also lower wear of the components of the drive system, a more precise setting of the process parameters such as, for example, the relative speed and thus an improved heat input into the workpiece. Furthermore, less energy need be expended in order to set the workpiece in rotation than with the conventional systems so that a cost reduction is also thereby possible.

According to one advantageous exemplary embodiment, at least one rotatable cylinder is configured as cylindrical friction roller that interacts with the workpiece in a friction-fit manner in order to move it. A particularly cost-effective drive unit can thereby be provided.

Here it is advantageous in particular when a weight force applied by the workpiece onto the rotatable cylinder determines a friction force between rotatable cylinder and workpiece. This makes it possible to design a friction roller even when no specifically designed friction surface additionally increases the friction force. With large and heavy workpieces, the weight force alone can in particular be enough that the rotatable cylinder can set the workpiece in rotation.

Of course, however, it is also possible that the rotatable cylinder includes a friction surfacing that increases a friction force between the rotatable cylinder and the workpiece. Here the friction surfacing can be produced from an elastomeric material or rubber material that on the one hand applies a high friction force to the workpiece and on the other hand, in particular due to its elasticity, can support the workpiece without damage.

It is also possible that with a plurality of support units equipped with a rotatable cylinder, the rotatable cylinders can be designed differently, so, for example, only one of the cylinders may include an elastomeric friction surfacing while the others have no friction surfacing or a different friction surfacing.

Furthermore, it is advantageous to design the rotatable cylinder as a releasable exchange element, in particular as a sleeve, that in the case of wear can be exchanged or can be adapted according to the shape of the workpiece.

Due to the configuring of the rotatable cylinder as a drive unit and the preferred designs described above, it can be ensured that even with thermal contraction or expansion of the component, an optimized drive of the workpiece is provided. Here it is furthermore advantageous when a measuring device, for example, a pressure sensor, that determines the weight force is provided on the drive unit. An embodiment is also advantageous here wherein, based on the measured weight force or a determined friction force, which can be composed of weight force and/or friction coefficient of the friction roller, a controller can control the drive unit such that the weight force and/or friction force is optimized. It can thereby be ensured that even with thermal expansion or contraction, or with structural asymmetries, such as, for example, an imbalance, the workpiece is nevertheless always driven with a constant force. Damage due to high force on the workpiece is also avoided.

Furthermore, by the determining/setting of the friction force, it can also be ensured that a slippage between the workpiece and the drive unit is minimized. In addition, the defined friction force allows a precise setting of the movement speed; in particular, it is possible to allow the workpiece to rotate with a defined speed.

According to a further preferred exemplary embodiment, the rotational axis of the at least one rotatable cylinder is configured perpendicular to a rotational axis of the workpiece. A tangentially oriented movement impulse can thereby be exerted from the cylinder onto the workpiece that is suitable to set the workpiece in motion and in rotation.

Furthermore, it is advantageous when each support unit includes a rotatable cylinder that abuts against the workpiece. It can thereby be ensured that the workpiece is moved in the workpiece holding device in a particularly low-friction manner. Here also only one of the rotatable cylinders can be configured as a drive unit and actively driven, while the other rotatable cylinders are not actively driven but rather are settable in rotation by the movement of the workpiece. This makes possible an energy-saving drive and at the same time a simple construction in terms of control technology since only a single drive unit is present. With a plurality of drive units it must be ensured that they rotate with the same speed in order to ensure a uniform drive movement. This in turn requires a more complex controlling (control device) than when only a single cylinder functions as a drive unit.

According to a further preferred exemplary embodiment, at least one rotational speed measuring unit is furthermore provided that determines a rotational speed of the driven rotatable cylinder and wherein preferably a further rotational speed measuring unit is provided on one of the passively rotating cylinders that determines a rotational speed of the passively driven cylinders and wherein furthermore a controller is provided that is designed to determine a slippage of the workpiece from a rotational speed difference between the actively and passively driven cylinders. In addition to the determination of the weight force described above, the rotational speed measurement can also be used to determine whether there is sufficient friction force of the driven cylinder.

In particular, it is advantageous when the controller is furthermore designed to increase the friction force in the event of exceeding of a predetermined rotational speed difference and/or to issue a notification about an increased slippage.

According to a further preferred exemplary embodiment, the support units, in particular the rotatable cylinders, are attached to carriers extending radially from a rotational center point of the workpiece. The discrete carriers allow a particularly free access to the workpiece, in particular even to the surface with which the workpiece abuts against the support units. Due to the discrete carriers, further components, such as, for example, an inductor of an induction hardening system, can also be placed at any location around the workpiece.

Here the rotatable cylinder is preferably disposed on the carrier displaceably in its position so that its position and the size and/or thickness (wall thickness/material thickness) of the workpiece to be treated can be adjusted. This design makes possible a workpiece holding device usable universally for various workpieces, which can easily be adjusted. In addition, the rotatable supporting of the cylinders on the carriers can be particularly simply designed.

According to a further preferred exemplary embodiment, the clamping units are also attached to carriers extending radially from a rotational center of the workpiece, wherein preferably the clamping unit is configured as a clamping cylinder whose longitudinal axis extends essentially perpendicular to a longitudinal axis of the carrier or of the rotatable cylinder. Analogously to the advantages described above, the carriers for the clamping units also offer a particularly free accessibility to the areas to be thermally treated.

The clamping units themselves ensure a secure and positionally accurate grip of the workpiece in the workpiece holding device. Here it is preferred in particular when the clamping units include at least one movable element, in particular a rotatable clamping cylinder, or are themselves configured as a movable element that is preloaded toward the workpiece such that the movement of the movable element follows the thermal expansion and/or contraction or an expansion and/or contraction due to a density difference in the microstructure during the phase transformation of the workpiece. The rotatable clamping cylinder is preferably a rotatable element abutting against the workpiece, the rotational axis of which rotatable clamping cylinder is preferably configured parallel to a rotational axis of the workpiece. It can thereby be ensured that during the clamping of the clamping units, positional inaccuracies of the workpiece can easily be corrected.

Of course, it is also possible to design one or more of the clamping cylinders as drive units, in particular as a friction wheel or a friction roller, that alternatively or in addition to one or more driven rotatable cylinders of the support unit provide for a moving of the workpiece. The advantages and embodiments mentioned for the rotatable cylinder, designed as a drive unit, of the support unit equally apply here for the clamping unit configured as a drive unit.

According to a further preferred exemplary embodiment, three carriers are respectively available for the support units and the clamping units; the carriers are each spaced from one another by an angle of approximately 120°. The three support units ensure a tilt-free supporting of the workpiece, while the three clamping units ensure a positionally accurate supporting. Here with the carriers including the clamping units, the clamping unit is preferably disposed on a radial outer end, while with the carriers including the support unit, and in particular the rotatable cylinder, these are adapted to the size and shape of the workpiece, their position depending on the size and/or thickness of the workpiece to be treated. Since both systems are disposed independently of each other and uniformly distributed around the circumference of the workpiece, an individually adjustable workpiece holding device is provided that can easily be adapted to the most diverse workpieces.

Alternatively, the clamping units and rotatable cylinders can respectively be attached to a common carrier. The number of components of the workpiece holding device can thereby be reduced without having to forgo their advantages. It is also advantageous here when the rotatable cylinder and the clamping unit are also designed as a combination element, which further reduces the number of components.

Furthermore, with a mounting of a clamping unit and a support unit on a common carrier, an exemplary embodiment is preferred in which three carriers are present that are each spaced from one another by an angle of approximately 120°. This allows a tilt-free supporting and uniform clamping with a minimal number of components.

Alternatively, clamping units and support units can also be provided on four carriers, wherein the four carriers are disposed distributed on the workpiece holding device in X arrangement.

The carriers are preferably disposed rotatably about each carrier bearing assembly, wherein the carrier bearing assembly can be disposed centrally on a carrier or on an axial end of the respective carrier. In particular, it is advantageous when the carrier bearing assembly does not coincide with the rotational center point of the workpiece but rather each carrier has its own carrier bearing assembly disposed eccentrically with respect to the rotational center point of the bearing. The eccentricity of the individual carrier bearing assemblies with respect to the rotational center point of the workpiece can be designed identical and/or different. In particular, mutually opposing carriers can have an identical eccentricity. This design is advantageous in particular for the carriers that carry the clamping units.

According to a further preferred exemplary embodiment, with rotationally symmetric workpieces a setting of the clamping force applied by the clamping units can be defined by an angular displacement of the carrier from a position of the carrier extending along the radius of the workpiece. Thus, for example, with a radially inwardly directed clamping force, i.e., a clamping of the workpiece with clamping units disposed radially outside the workpiece, an open, i.e., unclamped position can be achieved when the carrier is oriented exactly along the radius of the workpiece. With movement of the carrier out of this zero position, the clamping unit attached to the carrier approaches the radial outer surface of the workpiece and can exert a clamping force on the workpiece. In contrast, if the workpiece is clamped with a radially outwardly directed clamping force, i.e., with a clamping of the workpiece with clamping units disposed radially inside the workpiece, the clamping is increased when the carrier is rotated toward the orientation in the radius direction. In this case, a zero position is given over a certain maximum angular displacement, in particular at 45°, of the carrier with respect to the radius orientation.

This makes possible an exemplary embodiment wherein an adjusting of the clamping or clamping units is possible via a displacing of the carriers so that further movable elements for the providing of a clamping (see below) can be omitted. Here the clamping is preferred via displacing of the carriers, in particular in an X arrangement, and generally ensures a constant clamping and abutment of the clamping units even during an expansion/contraction of the workpiece during the heat treatment. This is made possible by the angle between the carriers not being held constant, but rather the carriers being able to be moved closer to each other or away from each other, which in turn ensures that even with a nonuniform contraction/expansion of the workpiece from the clamping units, ultimately a constant clamping is applied onto the workpiece.

Furthermore, it is advantageous to provide movable elements on the clamping units that can be formed separately or one-piece with the clamping cylinder and clamp the workpiece with an additional defined clamping force and defined force application points. With maintaining of a basic clamping, it can thereby be made possible to follow a workpiece shrinkage or a reduced workpiece growth due to the thermal contraction in the temperature range of the phase transformations Ferrite/alpha iron to austenite/gamma iron (A1 temperature to A3 temperature, at approximately 700° C. to 1150° C. depending on steel, microstructural condition, and heating speed) and/or due to the subsequent cooling. At the same time, however, due to the movable elements, a workpiece growth or the reduced workpiece shrinkage due to the volume increase during the quenching in the range of the phase transformation from austenite/gamma iron to martensite and/or bainite/pearlite/ferrite (depending on the solution state and steel, this temperature range of the martensite formation can typically fall at approximately 400° C. to 100° C.) can also be followed. Of course, however, the clamping cylinder itself can also represent the movable element.

Here it is advantageous in particular when, in an essentially rotationally symmetric workpiece, the movable element is axially, radially, and/or tangentially movable. Thus not only can thermal expansions/contractions, or expansions/contractions due to a density difference arising in the microstructure during the phase transformation, be supported, but also manufacturing tolerances, such as, for example, a certain ovality of the workpiece can be compensated for during the clamping. Such an adapting is advantageous in particular with workpieces with closed curves, such as, for example, elements of a plain or rolling-element bearing, bearing rings, gears, bolts, sleeves, discs, etc. In particular with annular workpieces, the clamping units are preferably displaceable radially, for example, by an electric or hydraulic drive, and prior to the thermal treatment are moved toward the workpiece until it is firmly held between the clamping units. In order to be able to compensate for manufacturing tolerances, one or more of the clamping units can be supported such that it is eccentrically displaceable. A further embodiment provides that clamping units, which hold a workpiece radially, in addition can also follow in the axial direction the thermal expansion/contraction or an expansion/contraction due to a density difference arising in the microstructure during the phase transformation. Here it is advantageous in particular when the movable element is formed as an eccentrically supported element, since the eccentric supporting provides both a radial and a tangential movability of the element.

According to a further preferred exemplary embodiment, a controller is furthermore provided that controls a contact force or clamping force of the clamping unit, wherein the controller is preferably designed to control the movement of the movable element. Thus, for example, the clamping unit can include at least one measuring device for the recording of shape and dimensional changes during the heating process and after the conclusion of the heating process (warpage). The data recorded can also be used for subsequent processing procedures in order to undertake individual-workpiece adaptations to the processes. In one preferred exemplary embodiment, at least one clamping unit, in particular the movable element, includes at least one force-measuring device that interacts with the controller and is configured to measure the contact force with which the clamping unit, in particular the movable element, abuts against the workpiece.

Furthermore, the movable element itself can also be configured as a drive unit.

According to a further advantageous exemplary embodiment, the clamping of the movable element is effected by a mechanical preload element. Mechanical preload elements can be easily installed and do not require additional controlling, which overall makes the workpiece holding device easily operable and cost-effective.

Here the mechanical preload element can be at least one spring element that interacts with the movable element and preloads the movable element toward the workpiece. For example, the spring element can be a wire spring, a plate spring, coil spring, and/or leaf spring, but plastics can also be used, such as, for example, an elastomer.

Furthermore, it is possible that the mechanical preload of the movable element is formed by a friction device that makes possible a movement of the movable element only after exceeding of a certain friction value. Based on the pressure that an expanding/contracting workpiece exerts on the movable element during a thermal processing, a movement of the movable element may thereby only be effected after exceeding of a certain threshold value.

Instead of a mechanical preload device, the preload of the movable element can also be effected by a device that is controllable by a controller. Here the preload can be effected, for example, by a hydraulically, pneumatically, or electrically operated element that follows the thermal expansion/contraction. For example, the movable element can be an oil or gas operated pressure damper.

A particularly precise following of the contraction/expansion is possible specifically with a preloading controlled with a controller. In order to further increase the accuracy and sensitivity of the following, the clamping unit, the support unit, and/or the drive unit can be equipped with at least one force measuring device that interacts with the controller and is designed to measure the contact force, clamping force, and/or friction force. Depending on this measured force, the controller can then control the clamping unit, the support unit, and/or the drive unit in order to exert a uniform force on the workpiece during the treatment. In addition, due to the force measuring device, an adapting to manufacturing inaccuracies is possible during the clamping of the workpiece into the workpiece holding device so that a uniform pressure on the various clamping units is already achieved during the clamping of the workpiece.

Alternatively or additionally, of course, the controller can also control the clamping unit, the support unit, and/or the drive unit based on a pre-calculated value table in order to be able to balance the calculated and anticipated expansions/contractions. Here the value table can be determined empirically and/or stored in a database that is accessible to the controller. This means the database can be stored internally in the controller itself or available in an external database.

In one preferred embodiment, the controller can also additionally react to forces that act on the workpiece due to the processing system and increase or decrease a preload in a manner depending on measured forces or proactively. For example, in anticipation of electrical, mechanical or magnetic forces that temporarily act on the workpiece, the current preload can be increased or decreased by a preload value in a controlled manner. This temporary superposition of the preload regulated based on the thermal expansion with a controlled offset can preferably be turned on and off. Here also, the clamping unit, support unit, and/or drive unit can be controlled based on a value table in order to be able to reliably support and/or balance the calculated and expected forces on the workpiece. Furthermore, the controller can be designed such that it can be switched from a regulated operation in which the preload forces are set based on measured values of the force measuring device, e.g., a load cell, to a controlled operation in which the preload forces are set based on a value table, and can correspondingly be switched back from the controlled operation into the regulated operation. Thus it is possible, for example, during a thermal expansion to regulate the preload to the greatest possible extent, or completely, based on a predetermined preload pressure, and during a subsequent thermal contraction, such as, for example, rapid quenching, to increase the preload pressure to a fixed value.

Here the value table or a setting of the clamping force, contact force, and/or friction force based on values of the value table, can depend in particular on measured and/or calculated temperature changes that are to be expected in the workpiece during the processing procedure.

According to a further advantageous exemplary embodiment, at least one of the clamping units is formed as an eccentrically supported clamping cylinder or slide shoe. The clamping cylinder and/or slide shoe can themselves be formed as movable or rotatable elements. However, alternatively or additionally it is also possible that they each include at least one further movable element. Furthermore, ribbings, or coatings made of, for example, friction particles, can advantageously be applied to the clamping cylinder; the ribbings or coatings facilitate the contact with the workpiece and ensure a movement/drive of the workpiece in the workpiece holding device.

The clamping units, support units, and/or drive units of the workpiece holding device can be individually or jointly controllable.

In order that the clamping units, support units, and/or drive units do not themselves experience too large a thermal expansion/contraction, they are advantageously made from a temperature-resistant material, such as, for example, ceramic, polymer ceramic, aluminum silicate, stone, fireclay or from special steel alloys.

A further exemplary embodiment comprises a workpiece holding device for holding an annular workpiece in a heat treatment system while the workpiece undergoes a thermal expansion and/or contraction which holding device includes a first rotatable support cylinder, a second rotatable support cylinder and a third rotatable support cylinder each having a cylindrical side surface configured to support the workpiece and each having a longitudinal axis of rotation lying in a plane and extending away from a center point. The device also includes a first carrier supporting a first clamping cylinder, a second carrier supporting a second clamping cylinder and a third carrier supporting a third clamping cylinder, each of the first, second and third carriers having an end closest to the centerpoint that is pivotably supported such that pivoting the carrier moves a respective clamping cylinder toward the workpiece to clamp the workpiece with a predetermined force. The first rotatable support cylinder is configured to be driven to rotate the workpiece relative to the workpiece holding device, and the carriers are configured to pivot to maintain the predetermined force while the workpiece undergoes the thermal expansion or contraction. In addition, the first rotatable support cylinder may be mounted on the first carrier or on a separate fourth carrier, the second rotatable cylinder may be mounted on the second carrier or on a separate fifth carrier, and the third rotatable cylinder may be mounted on the third carrier or on a separate sixth carrier. The longitudinal axis of rotation of each of the rotatable support cylinders may be perpendicular to an axis of rotation of each of the first, second and third clamping cylinders.

A further aspect of the present invention relates to a method for thermally treating a workpiece that is received in a workpiece holding device as described above, wherein the method includes the following steps:
inserting the workpiece into the workpiece holding device;
clamping the clamping units until each clamping unit contacts the workpiece and abuts against the workpiece with a predeterminable, preferably equally high, clamping force;
activating the drive unit for the moving of the workpiece in the workpiece holding device;
starting the thermal treatment;
actively or passively readjusting the clamping units and/or drive unit during the thermal treatment so that a predetermined clamping force, friction force, and/or contact force applies between clamping unit and/or drive unit during predeterminable time periods or the entire thermal treatment.

Deformations during the thermal treatment of the workpiece can thereby be minimized.

Further advantages and advantageous embodiments are specified in the description, the drawings, and the claims. Here in particular the combinations of features specified in the description and in the drawings are purely exemplary so that the features can also be present individually or combined in other ways.

In the following the invention is described in more detail using the exemplary embodiments depicted in the drawings. Here the exemplary embodiments and the combinations shown in the exemplary embodiments are purely exemplary and are not intended to define the scope of the invention. This scope is defined solely by the pending claims.

### BRIEF DESCRIPTION OF THE DRAWINGS

FIG. 1 is a schematic depiction of an induction hardening system with a workpiece holding device according to a preferred exemplary embodiment of the present disclosure.

FIG. 2 is a schematic depiction of a workpiece holding device according to a further preferred exemplary of the present disclosure.

FIG. 3 is a schematic depiction of a clamping possibility of clamping units in the workpiece holding device according to FIG. 2.

FIG. 4 is a schematic depiction of a workpiece holding device according to a further preferred exemplary embodiment of the present disclosure.

FIG. 5 is a schematic depiction of a workpiece holding device according to a further preferred exemplary embodiment of the present disclosure.

### DETAILED DESCRIPTION

In the following, identical or functionally equivalent elements are designated by the same reference numbers.

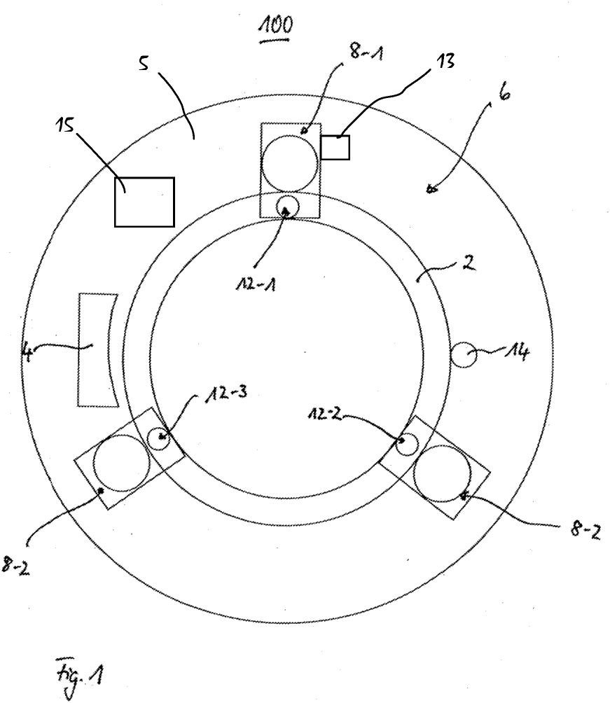

FIG. 1 schematically shows a plan view of an induction hardening system 100 that is designed to inductively harden a workpiece 2, e.g., a bearing ring, with the aid of an inductor 4. Here the induction hardening system 100 depicted in FIG. 1 is formed as a hardening system in which the inductor 4 always heats only one part of the workpiece 2 while the workpiece 2 is moved past the inductor 4. For this purpose the workpiece 2 is clamped into a main body portion 5 of a workpiece holding device 6 and moved past the inductor 4. For the receiving of the workpiece 2, the workpiece holding device 6 includes clamping units 8-1, 8-2, 8-3 that are designed to hold the workpiece 2.

Furthermore, FIG. 1 shows that in the exemplary embodiments depicted, the workpiece 2 lies against three support units 12-1, 12-2, 12-3.

Now instead of, as in the prior art, rotating the entire system 6 in order to move the workpiece 2 past the inductor 4, a drive unit 14 is now furthermore provided that is designed to rotate only the workpiece 2. Of course, more than one drive unit 14 can also be present.

Here the drive unit 14 can be, for example, a friction wheel or a friction roller that acts directly onto the workpiece 2 and sets it in rotation. Instead of a separate drive device 14 as depicted in FIG. 1, one of the clamping units 8 and/or of the support units 12 can also be configured as a drive unit 14. Thus, for example, the clamping unit 8-1 can be configured simultaneously as a friction wheel or a friction roller that in turn acts directly on the workpiece 2 and sets it in rotation.

The clamping units 8, the support units 12, and/or the drive unit 14 can be moved radially, axially, circumferentially and/or tangentially in order to optimally abut against the workpiece 2. Furthermore, on one or more of the units 8, 12, 14 it is possible to attach one or more measuring devices 13 that are designed to measure a contact force and/or clamping force and/or friction force between the clamping units 8 and/or the support units 12 and/or the drive unit 14 and the workpiece 2. Furthermore, a controller 15 can also be provided that interacts with the units 8, 12 and 14 such that the units 8, 12, 14 interact with the workpiece 2 with a predetermined contact force, clamping force, and/or friction force.

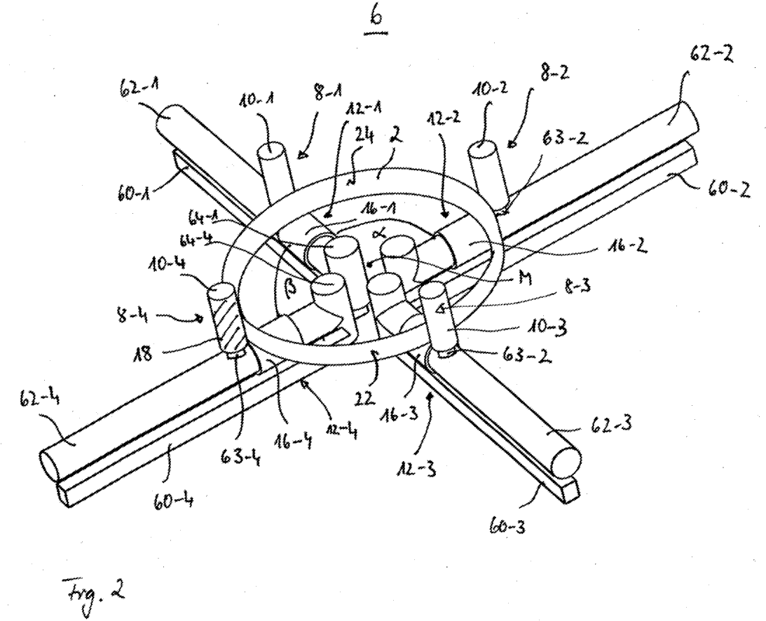

FIG. 2 shows a schematic-perspective view of a first preferred embodiment of a workpiece holding device 6 that can be used in an induction hardening system 100 as schematically depicted in FIG. 1. In the exemplary embodiment depicted, the workpiece holding device 6 comprises four carriers 60-1, 60-2, 60-3, 60-4 that each carry rod-shaped, in particular cylindrical, shafts 62-1, 62-2, 62-3, 62-4. Here the carriers 60 and the shafts 62 can also be configured as one-piece integral elements. The shafts 62 and the carriers 60 in turn are rotatably attached to bearing assemblies 64 so that the carriers 60 extend radially outward from a rotational center M, wherein the rotational center M is determined by the rotation of the workpiece 2 in the workpiece holding device 6.

Furthermore, it can be seen from FIG. 2 that in the region wherein the workpiece 2 rests on the carriers 60, cylindrical contact elements 16-1, 16-2, 16-3, 16-4 are provided that are rotatably disposed on the carriers 60. Due to the rotatability of the cylindrical contact elements 16-1, 16-2, 16-3, 16-4, the workpiece 2 can easily be set in rotation. For this purpose, one of the rotatable cylinders 16 can be actively driven, that is, set in rotation, whereby the workpiece 2 is set in motion due to the friction between the cylinder 16 and the workpiece 2.

Of course, more cylinders 16, or all cylinders 16, can also be actively driven.

Furthermore, FIG. 2 shows that on the carriers 60, and in particular on the shafts 62, clamping units 8-1, 8-2, 8-3, 8-4 are provided in the form of clamping elements 10-1, 10-2, 10-3, 10-4, that are designed to secure the workpiece 2 in its position. For this purpose, the clamping devices 8 can be set, for example, radially against the carriers 60 or against the shaft 62 until they contact the workpiece 2 and secure it in its position.

As depicted in FIG. 2, the clamping units 8 include clamping cylinders 10. The clamping cylinders 10 can be designed as sleeves and be releasably, and preferably rotatably, slipped onto hubs 63. Here it is advantageous in particular when the clamping cylinder 10, together with its hub 63, is radially displaceable along the carrier 60 or the shaft 62 in order to be adapted to different workpieces 2 or in order to, for example, exert a clamping force on a radially inner surface 24 of the workpiece 2 instead of the clamping force depicted here on a radially outer surface 22 of the workpiece 2.

Alternatively or additionally, one of the clamping units, for example, 8-3, can function as a drive unit 14 and then instead of a clamping cylinder 10-3 carries a friction roller 18 that frictionally abuts against the workpiece 2 and is actively set in rotation in order to rotate the workpiece 2. The driven clamping roller/friction roller 18 can be present alternatively or in addition to a driven cylinder 16.

In addition to the radial adjustability of the clamping units 8, in addition it can also be provided that the carriers 60 are themselves movable and can be brought from an open position in which the workpiece 2 can be placed in the workpiece holding device 6 and against the cylindrical rollers 16, into a closed position in which the workpiece is clamped in the clamping units 8 and they abut against the workpiece 2 with clamping force. For this purpose the carriers 60 are rotatably supported on carrier bearing assemblies 64-1, 64-2, 64-3, 64-4. The carrier bearing assemblies 64 are in turn disposed eccentrically with respect to the rotational center M of the workpiece.

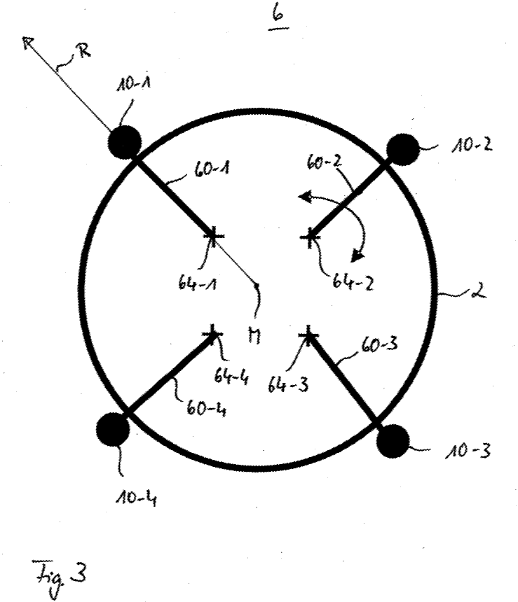

FIG. 3 schematically shows the design from FIG. 2, and the clamping possibility corresponds to that in the exemplary embodiment depicted in FIG. 2. Since, as mentioned above, the carriers 60 are not supported in the rotational center M but rather are eccentrically supported at points 64-1, 64-2, 64-3 and 64-4, the distance between the clamping elements 8 and the workpiece 2 can be maximized or minimized depending on the position of the carriers. Thus, for example, in a so-called zero position, the distance between clamping unit 8 and the workpiece 2 can be maximized so that the workpiece 2 can be inserted into the workpiece holding device 6 without it contacting the clamping unit. In the exemplary embodiment depicted, this is possible with an orientation of the carriers in the radius direction of the workpiece. That is, when the carrier is oriented precisely in the radius direction R of the workpiece 2 (see FIG. 3), the distance between workpiece 2 and clamping unit 8 is maximized. With an angular adjustment about the zero position (see arrow), the clamping unit 8 approaches the workpiece 2 until the clamping unit 8 abuts against the workpiece 2 and can exert a clamping force. This applies to the design shown in FIGS. 2 or 3, in which a radially inwardly directed clamping force is applied, and the clamping units 8 are disposed radially outside on the workpiece 2.

In contrast, if the workpiece is clamped with a radially outwardly directed clamping force, i.e., with a clamping of the workpiece with clamping units disposed radially inside the workpiece, the clamping is increased when the carrier is rotated toward the orientation in the radius direction. In this case, a zero position is given over a certain maximum angular displacement, in particular at 45°, of the carrier with respect to the radius orientation.

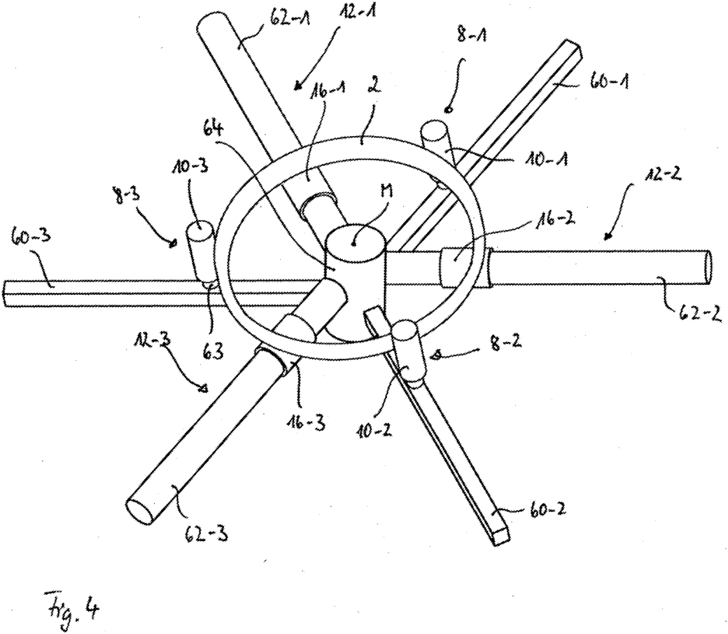

FIG. 4 shows another preferred exemplary embodiment in which the support units 12 and the clamping units 8 are attached on separate carriers 62 or 60. Here the workpiece 2 again abuts against rotatably supported cylinders 16-1, 16-2, 16-3. In addition, FIG. 4 shows that three support units 12 or 3 clamping units 8 are provided. The drive unit 14 can in turn be integrated into the cylindrical elements 16 or into the clamping units 8 in order to set the workpiece 2 in rotation.

The clamping units 8 can in turn also include clamping cylinders 10-1, 10-2 and 10-3 that can be moved radially in order to exert a clamping on the workpiece 2 and to hold it in position.

Here too, the rotatable cylinders 16 provide for a low-friction and tilt-free supporting of the workpiece 2 and simultaneously for a particularly good accessibility to the surfaces to be treated.

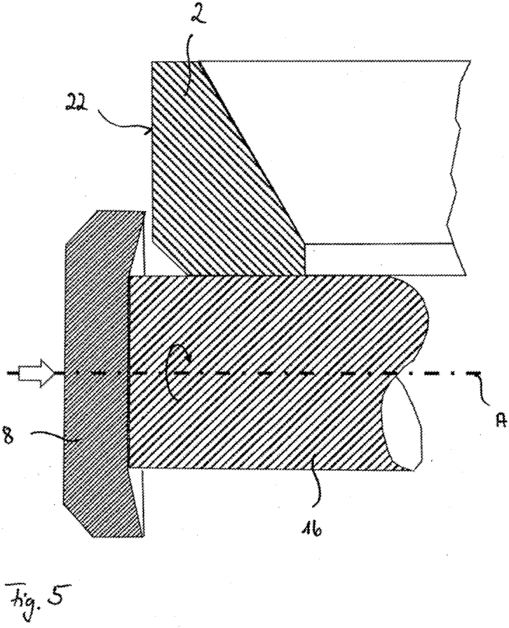

FIG. 5 shows a further preferred exemplary embodiment in which the rotatable cylinder 16 and a clamping unit 8 formed as friction wheel 18 are present as a combined element. Here the friction wheel 18 abuts against the radial outer surface 22 of the workpiece and can thus simultaneously exert a clamping force on the workpiece 2. Thus the friction wheel 18 also assumes the function of the clamping unit 8. During rotation of the cylinder 16 about its longitudinal axis A, the friction wheel 18 is simultaneously rotated. Due to the abutment (friction) of the friction wheel 18 against the outer surface 22 of the workpiece, the rotational movement of the cylinder 16 is also transmitted via the friction wheel 18 onto the workpiece 2 so that the workpiece 2 is also rotated.

In summary, with the presented workpiece holding device it can be achieved that a particularly good contact and accessibility of the workpiece can be achieved in the workpiece holding device, wherein the workpiece is simultaneously easily movable via the support unit. In addition, a clamping of the clamping elements can also be made possible without additional elements. This is achieved via the eccentric supporting of carriers that can bring the clamping units closer to or farther away from their contact surface on the workpiece.

As used herein, a controller can be a programmable hardware component which can be formed by a processor, a computer processor (CPU = central processing unit), an application-specific integrated circuit (ASIC), an integrated circuit (IC), a computer, a system-on-a-chip (SOC), a programmable logic element, or a field programmable gate array (FGPA) including a microprocessor.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved workpiece holding devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

| | |
|---|---|
| 100 | Hardening system |
| 2 | Workpiece |
| 4 | Induction coil |
| 5 | Main body portion |
| 6 | Workpiece holding device |
| 8 | Clamping unit |
| 10 | Clamping element |
| 12 | Support unit |
| 13 | Measuring device |
| 14 | Drive unit |
| 15 | Controller |
| 16 | Cylindrical contact element |
| 18 | Friction roller |
| 22 | Radially outer side of the workpiece |
| 24 | Radially inner side of the workpiece |
| 60 | Carrier |
| 62 | Rod-shaped shaft |
| 63 | Hub |
| 64 | Bearing assembly |

What is claimed is:

1. A workpiece holding device for holding a workpiece in a heat treatment system while the workpiece undergoes a thermal expansion and/or contraction, the workpiece holding device comprising:
at least two clamping units configured to apply a radial and/or an axial clamping force to the workpiece to hold the workpiece in the workpiece holding device in a predefined position, and
at least three support units configured to support the workpiece,
wherein a first one of the at least three support units includes a first cylinder configured to support the workpiece, the first cylinder having a longitudinal axis and being configured to rotate around the longitudinal axis.

2. The workpiece holding device according to claim 1,
wherein the workpiece is supported on the first cylinder such that rotating the first cylinder causes the workpiece to rotate in the workpiece holding device.

3. The workpiece holding device according to claim 2,
wherein the first cylinder is a friction roller that frictionally engages the workpiece.

4. The workpiece holding device according to claim 3,
wherein a weight of the workpiece determines a friction force between the friction roller and the workpiece.

5. The workpiece holding device according to claim 2,
wherein the first cylinder includes a friction surfacing that increases a friction force between the first cylinder and the workpiece.

6. The workpiece holding device according to claim 2,
wherein the longitudinal axis of the first cylinder is perpendicular to a rotational axis of the workpiece.

7. The workpiece holding device according to claim 1,
wherein a second one of the at least three support units includes a second cylinder configured to support the workpiece, the second cylinder having a longitudinal axis and being configured to rotate around the longitudinal axis of the second cylinder, and
wherein a third one of the at least three support units includes a third cylinder configured to support the workpiece, the third cylinder having a longitudinal axis and being configured to rotate around the longitudinal axis of the third cylinder.

8. Workpiece holding device according to claim 6,
wherein the first cylinder is configured to be actively driven and the second and third cylinders are configured to be passively set in rotation by a rotation of the workpiece.

9. The workpiece holding device according to claim 8,
including a first carrier supporting the first cylinder, a second carrier supporting the second cylinder and a third carrier supporting the third cylinder,
wherein each of the first, second and third carriers extends radially away from a rotational centerpoint of the workpiece.

10. The workpiece holding device according to claim 9,
wherein each of the at least two clamping units includes a clamping cylinder having an axis of rotation parallel to an axis of rotation of the workpiece, and
wherein one of the at least two clamping cylinders is attached to each of the first, second and third carriers.

11. The workpiece holding device according to claim 10,
wherein a radially inner end of each of the first, second and third carriers is pivotably supported such that the carrier is pivotable relative to the workpiece.

12. The workpiece holding device according to claim 10,
wherein the first, second and third carriers are spaced from one another by an angle of approximately 120°.

13. A workpiece holding device according to claim 8, including:
at least two carriers comprising: a first carrier supporting the first cylinder, a second carrier supporting the second cylinder, a third carrier supporting the third cylinder, a fourth carrier supporting a first one of the at least two clamping units, a fifth carrier supporting a second one of the at least two clamping units and a sixth carrier supporting a third one of the at least two clamping units.

14. The workpiece holding device according to claim 11, wherein the at least two carriers are equally angularly spaced.

15. A method comprising:
providing a workpiece holding device according to claim 1,
placing the workpiece onto the at least three support units of the workpiece holding device,
applying a predetermined force to the workpiece with the at least two clamping units,
rotating a first one of the at least three support units to rotate the workpiece in the workpiece holding device,
performing a thermal treatment on at least a portion of the workpiece in the workpiece holding device, and
while performing the thermal treatment, adjusting the at least two clamping units to maintain the predetermined clamping force.

16. A workpiece holding device for holding an annular workpiece in a heat treatment system while the workpiece undergoes a thermal expansion and/or contraction, the workpiece holding device comprising:
a first rotatable support cylinder, a second rotatable support cylinder and a third rotatable support cylinder each having a cylindrical side surface configured to support the workpiece and each having a longitudinal axis of rotation lying in a plane and extending away from a center point,
a first carrier supporting a first clamping cylinder, a second carrier supporting a second clamping cylinder and a third carrier supporting a third clamping cylinder, each of the first, second and third carriers having an end closest to the centerpoint that is pivotably supported such that pivoting the carrier moves a respective clamping cylinder toward the workpiece to clamp the workpiece with a predetermined force,
wherein the first rotatable support cylinder is configured to be driven to rotate the workpiece relative to the workpiece holding device, and
wherein the carriers are configured to pivot to maintain the predetermined force while the workpiece undergoes the thermal expansion or contraction.

17. The workpiece holding device according to claim 16,
wherein the first rotatable support cylinder is mounted on the first carrier and the second rotatable cylinder is mounted on the second carrier and the third rotatable cylinder is mounted on the third carrier,
and wherein the longitudinal axis of rotation of each of the rotatable support cylinders is perpendicular to an axis of rotation of each of the first, second and third clamping cylinders.

18. The workpiece holding device according to claim 16,
including a fourth carrier supporting the first rotatable support cylinder, a fifth carrier supporting the second rotatable support cylinder and a sixth carrier supporting the third rotatable support cylinder.
